(19) United States
(12) Patent Application Publication
(10) Pub. No.: US 2026/0257362 A1
(43) Pub. Date: Sep. 3, 2026

(54) ROBOT SYSTEM, AND DIAGNOSTIC DEVICE, DIAGNOSTIC METHOD, AND RECORDING MEDIUM STORING DIAGNOSTIC PROGRAM FOR ROBOT (as amended)

(71) Applicant: FANUC CORPORATION, Yamanashi (JP)

(72) Inventors: Kazuki WAKABAYASHI, Yamanashi (JP); Masumi ONO, Yamanashi (JP); Hiroshi NAKAGAWA, Yamanashi (JP)

(21) Appl. No.: 18/881,892

(22) PCT Filed: Sep. 9, 2022
(86) PCT No.: PCT/JP2022/033823

§ 371 Date: Jan. 7, 2025

(51) Int. Cl. B25J 9/16; B25J 9/06

(52) U.S. Cl. CPC B25J 9/1674; B25J 9/06; B25J 9/1694

(57) ABSTRACT

A robot system includes: a robot that has two or more joints; a sensor that is capable of detecting a physical amount for measuring or estimating an external force acting on the robot; and a diagnostic device that diagnoses the robot, wherein the diagnostic device calculates a force that acts on each joint in at least one direction other than the direction in which each joint operates, on the basis of the external force measured or estimated from the physical amount detected by the sensor.

### CROSS-REFERENCE TO RELATED APPLICATION(S)

This is a National Stage Entry into the United States Patent and Trademark Office from International Patent Application No. PCT/JP2022/033823, filed on Sep. 9, 2022, the entire contents of which are incorporated herein by reference.

### FIELD OF THE INVENTION

The present disclosure relates to a robot system, and a diagnostic device, a diagnostic method, and a diagnostic program for a robot.

### BACKGROUND OF THE INVENTION

In a known control method, joints of an articulated robot are driven to bring a tool attached to the distal end of a robot body to a predetermined target position (for example, see Japanese Unexamined Patent Application, Publication No. 2008-000861).

In this control method, in order to monitor the state of each joint when an external force is input to the robot body, the load about a drive shaft applied to each joint is estimated on the basis of the torque about a drive shaft of an actuator of that joint. In this control method, it is determined whether or not the estimated load is higher than a preset threshold, and, when it is determined that the estimated load is higher than or equal to the threshold, the driving direction of that joint is changed.

### SUMMARY OF THE INVENTION

An aspect of the present disclosure is a robot system comprising: a robot having two or more joints; a sensor capable of detecting a physical quantity for measuring or estimating an external force acting on the robot; and a diagnostic device that diagnoses the robot. The diagnostic device calculates a force acting on each joint in at least one direction other than an operation direction of that joint on a basis of the external force measured or estimated from the physical quantity detected by the sensor.

### BRIEF DESCRIPTION OF THE DRAWINGS

FIG. 1 schematically shows the overall configuration of a robot system according to a first embodiment of the present disclosure.

FIG. 2 is a partial enlarged perspective view showing a state in which an external force is applied to a tool at the distal end of the robot in FIG. 1.

FIG. 3 is a block diagram showing the configuration of a control device in FIG. 1.

FIG. 4 is a flowchart for explaining the operation of the control device in FIG. 1.

FIG. 5 is a graph showing a moment in a direction about an axis, acting on a joint at the distal end of the robot in FIG. 1.

FIG. 6 is a graph showing a force in an axial direction, orthogonal to an axis, acting on a joint at the distal end of the robot in FIG. 1.

FIG. 7 schematically shows the overall configuration of a robot system according to a second embodiment of the present disclosure.

FIG. 8 is a block diagram showing the configuration of a control device in FIG. 7.

FIG. 9 is a flowchart for explaining the operation of the control device in FIG. 7.

### DESCRIPTION OF EMBODIMENT(S) OF THE INVENTION

A robot system 100, a diagnostic device 30, a diagnostic method, and a diagnostic program according to a first embodiment of the present disclosure will be described below with reference to the drawings.

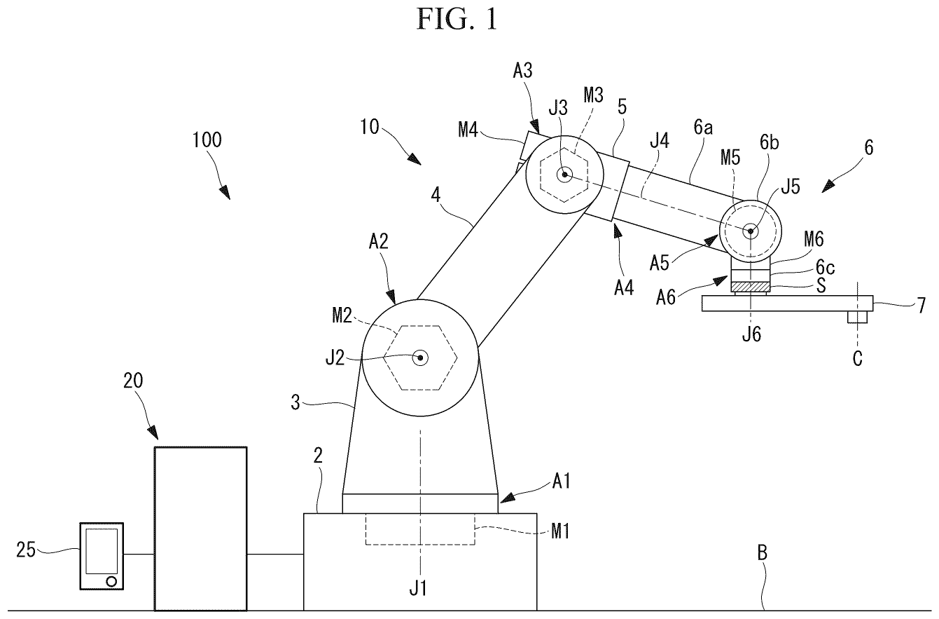

The robot system 100 according to this embodiment includes, for example, a six-axis vertical articulated robot 10 (hereinbelow, referred to as a robot 10) that performs a predetermined task and a control device 20 that controls the robot 10, as illustrated in FIG. 1.

As shown in FIG. 1, the robot 10 includes, for example, a base 2 installed on a horizontal floor B, and a revolving drum 3 supported so as to be rotatable about a vertical first axis J1 (hereinbelow, also referred to as an axis J1) relative to the base 2. The robot 10 also includes a first arm 4 supported so as to be rotatable about a horizontal second axis J2 (hereinbelow, also referred to as an axis J2) relative to the revolving drum 3. The robot 10 also includes a second arm 5 supported so as to be rotatable about a horizontal third axis J3 (hereinbelow, also referred to as an axis J3) relative to the distal end of the first arm 4.

The robot 10 further includes a three-axis wrist unit 6 supported at the distal end of the second arm 5.

The wrist unit 6 includes a first wrist component 6a supported so as to be rotatable about a fourth axis J4 (hereinbelow, also referred to as an axis J4), which is in a twisted positional relationship with the axis J3, relative to the second arm 5. The wrist unit 6 also includes a second wrist component 6b supported so as to be rotatable about a fifth axis J5 (hereinbelow, also referred to as an axis J5), which is orthogonal to the axis J4, relative to the first wrist component 6a.

The wrist unit 6 further includes a third wrist component 6c supported so as to be rotatable about a sixth axis J6 (hereinbelow, also referred to as an axis J6), which is orthogonal to the axis J5, relative to the second wrist component 6b. The robot 10 includes six joints A1 to A6.

A tool 7 for performing a task on a workpiece is attached to the third wrist component 6c. Examples of the tool 7 include a nut runner used for a screw fastening task and a grinder used for a polishing task.

The joint A1 is a rotary joint that rotates the revolving drum 3 about the first axis (rotation axis) J1 relative to the base 2 by means of a motor M1. The joint A2 is a rotary joint that rotates the first arm 4 about the second axis (rotation axis) J2 relative to the revolving drum 3 by means of a motor M2. Furthermore, the joint A3 is a rotary joint that relatively rotates the first arm 4 and the second arm 5 about the third axis (rotation axis) J3 by means of a motor M3.

The joint A4 is a rotary joint that relatively rotates the second arm 5 and the first wrist component 6a about the fourth axis (rotation axis) J4 by means of a motor M4. The joint A5 is a rotary joint that relatively rotates the first wrist component 6a and the second wrist component 6b about the fifth axis (rotation axis) J5 by means of a motor M5. The joint A6 is a rotary joint that relatively rotates the second wrist component 6b and the third wrist component 6c about the sixth axis (rotation axis) J6 by means of a motor M6.

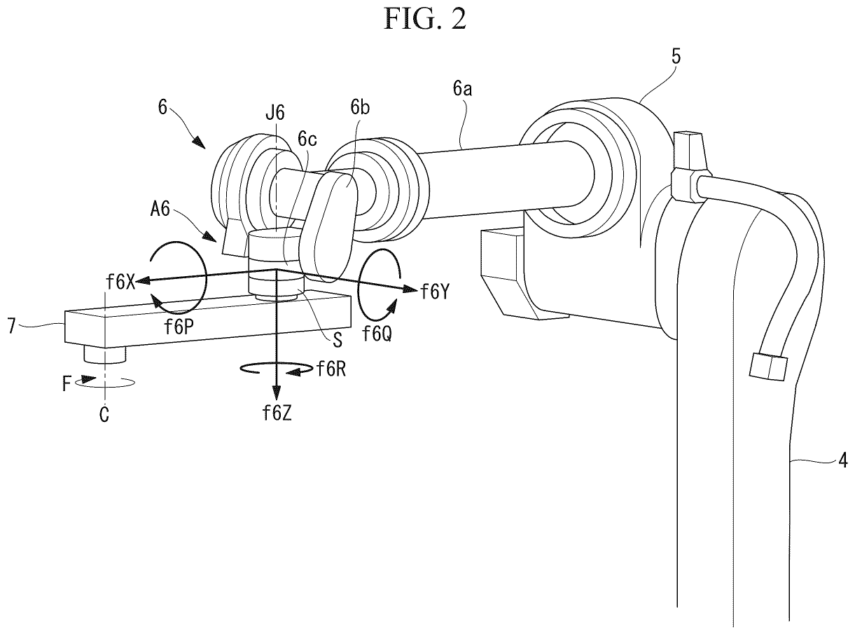

The joints A1 to A6 are provided with decelerators (not shown) for reducing the rotational speeds of the motors M1 to M6, respectively. A sensor S for detecting a force acting on the tip of the robot 10 is attached between the third wrist component 6c and the tool 7. The sensor S is, for example, a six-axis force sensor that can detect a total of six components, including forces in three mutually orthogonal axial directions of a sensor coordinate system (see FIG. 2) fixed to the center of the distal end of the third wrist component 6c and moments about the three axes.

As shown in FIG. 2, the robot 10 moves the tool 7 attached to the wrist unit 6 to a position required for the task and operates the tool 7 in that state to perform a predetermined task on a workpiece (not shown). The sensor S detects a force Fs acting on the distal end of the third wrist component 6c by means of a reaction force (external forces) F acting on the tip of the tool 7 due to the task.

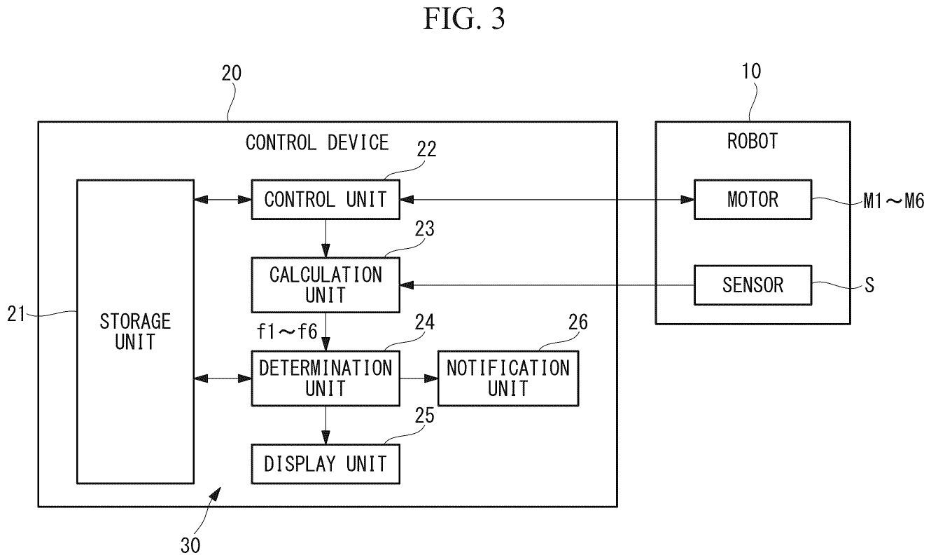

As shown in FIG. 3, the control device 20 includes a storage unit 21 that stores various programs and the like, and a control unit 22 that controls the motors M1 to M6 of the robot 10 in accordance with the programs stored in the storage unit 21. Each of the motors M1 to M6 includes an encoder (not shown). Rotation angle information of each of the motors M1 to M6 detected by the encoder is fed back to the control unit 22. The control unit 22 controls the tool 7 in accordance with the programs stored in the storage unit 21.

The control device 20 also includes the diagnostic device 30 according to an embodiment of the present disclosure. The diagnostic device 30 includes a calculation unit 23, a determination unit 24, a display unit 25, and a notification unit 26. A part of the storage unit 21 constitutes the diagnostic device 30. The storage unit 21 is a memory such as a ROM and a RAM, and the control unit 22 and the diagnostic device 30 include a processor and a memory.

The storage unit 21 stores at least one operation program for causing the robot 10 to perform a predetermined operation and a diagnostic program for diagnosing whether an excessive load is applied to the joints A1 to A6 of the robot 10. The diagnostic program may be included in the operation program as a part of the operation program, or may be executed independently of the operation program.

The storage unit 21 also stores allowable values for multiple direction components of loads f1 to f6 acting on the joints A1 to A6. For example, for the joint A1, the storage unit 21 stores allowable values of the force in the direction along the axis J1, the moment about the axis J1, the force in an arbitrary direction orthogonal to the axis J1, and the moment about an arbitrary axis orthogonal to the axis J1.

The allowable values are set in advance according to the values, such as withstand loads, of members, such as the motors M1 to M6, the decelerators, and the bearings (not shown), constituting the respective joints A1 to A6.

The calculation unit 23 calculates the loads f1 to f6 acting on the joints A1 to A6 due to the external force F on the basis of, for example, six direction components of the force Fs detected by the sensor S and the posture information of the robot 10 at the time when the force Fs is detected. For the posture information of the robot 10, information calculated by the control unit 22 on the basis of rotation angle information from the encoders provided in the motors M1 to M6 is used.

The loads f1 to f6 acting on the joints A1 to A6 include forces or moments having multiple direction components. The calculation unit 23 calculates forces and moments in multiple directions acting on the joints A1 to A6. For example, for the joint A1, the calculation unit 23 calculates the force in the direction along the axis J1, the moment about the axis J1, the force in an arbitrary direction orthogonal to the axis J1, and the moment about the axis in an arbitrary direction orthogonal to the axis J1. The same applies to the joints A2 to A6. Specifically, the calculation unit 23 also calculates forces in directions other than the rotation directions (driving directions) about the axes J1 to J6 of the joints A1 to A6.

The determination unit 24 compares the forces and the moments in the respective directions acting on the joints A1 to A6 calculated by the calculation unit 23 with the corresponding allowable values, and determines whether or not the forces and the moments exceed the allowable values. More specifically, the determination unit 24 calculates the ratios between the forces and the moments calculated by the calculation unit 23 and the corresponding allowable values stored in the storage unit 21, and determines whether the ratios exceed 100%.

In addition, the determination unit 24 transmits, to the display unit 25, the ratio of the direction component having the largest ratio, together with the determination result, for each of the joints A1 to A6.

The display unit 25 is a monitor and displays the determination result and the ratio transmitted from the determination unit 24. In the example shown in FIG. 1, the display unit 25 is provided on a teaching operation panel provided in the control device 20. The display unit 25 may be provided in the control device 20, or may be provided in another computer or the like that can receive a signal from the control device 20. In addition, when there is a joint in which the ratio exceeds 100%, the display unit 25 may change the display color for displaying that joint, so that the color is different from the display color of the other joints. Alternatively, only the joints A1 to A6 that have been determined by the determination unit 24 to have a ratio greater than 100% and the largest ratios in these joints may be displayed.

The notification unit 26 receives the determination result from the determination unit 24, and, when the ratio exceeds 100%, notifies the outside of the fact. The notification unit 26 is, for example, a monitor, a speaker, or an indicator lamp; anything that prompts the operator to check the display unit 25 may be used.

The thus-configured robot system 100 and a robot diagnostic method using the diagnostic device 30 according to this embodiment will be described below.

As shown in FIG. 2, an example case in which a nut runner, serving as the tool 7, is attached to the wrist unit 6 at the distal end of the robot 10, and a screw fastening task is performed on a predetermined workpiece will be described below.

First, when the operation program stored in the storage unit 21 of the control device 20 is executed, the control unit 22 controls the drive currents supplied to the motors M1 to M6 to change the posture of the robot 10. As a result, the tool 7 attached to the wrist unit 6 of the robot 10 is disposed at a position and in an orientation in which the tool 7 can perform a screw fastening task on the workpiece.

Furthermore, by the control unit 22 operating the tool 7, a rotational force about an axis C of the screw is applied to the screw (not shown) set in the workpiece, and the screw fastening task is performed. At this time, the tip of the tool 7 is subjected to a reaction force F in the direction opposite to the force about the axis C applied to the screw. This reaction force F is transmitted to the joints A1 to A6 via the tool 7 and acts as the loads f1 to f6 on the joints A1 to A6, respectively.

In this case, according to this embodiment, the diagnostic device 30 included in the control device 20 executes the diagnostic program stored in the storage unit 21. The diagnostic program is executed in parallel with the operation program executed by the control device 20.

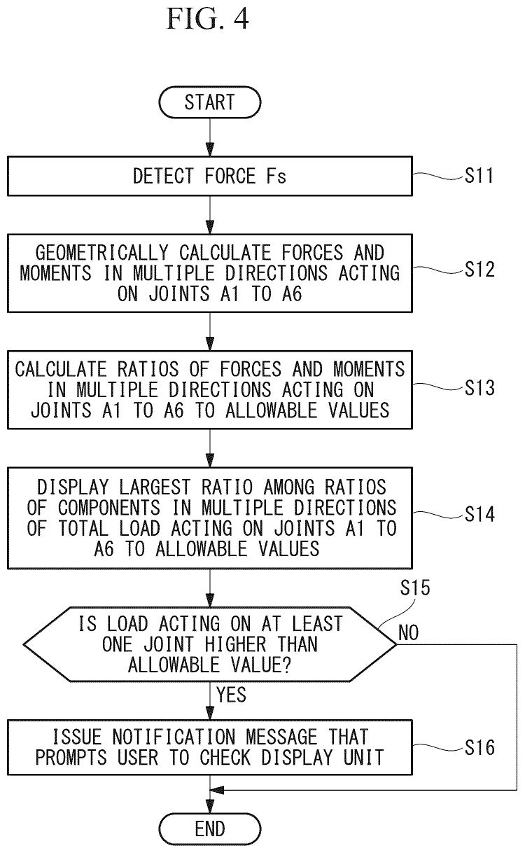

A diagnostic method according to the execution of the diagnostic program will be described below with reference to the flowchart shown in FIG. 4.

First, when the reaction F acts on the tool 7, the force Fs acting on the third wrist component 6c is detected by the sensor S attached between the tool 7 and the third wrist component 6c at predetermined sampling intervals. Then, six direction components of the detected force Fs in the sensor coordinate system (see FIG. 2) are detected (step S11). Then, the six direction components of the force Fs detected by the sensor S are transmitted to the calculation unit 23.

Next, the calculation unit 23 receives the force Fs from the sensor S and receives rotation angle information of the motors M1 to M6 at the time when the force Fs is detected by the sensor S, which has been fed back to the control unit 22. Then, the calculation unit 23 geometrically calculates forces and moments in multiple directions acting on the joints A1 to A6 on the basis of the force Fs and the rotation angle information of the motors M1 to M6 (step S12).

For example, the calculation unit 23 calculates the forces in the axial directions of the axes J1 to J6 of the joints A1 to A6 and the moments about the axes. The calculation unit 23 also calculates the maximum forces and moments among the forces in the axial directions orthogonal to the axes J1 to J6 and the moments about the axes.

More specifically, for example, in order to calculate the load f6 acting on the joint A6 due to the external force F input to the tool 7, first, expressions (1) and (2) below are calculated. By doing so, a force f6Z in the axial direction of the axis J6 of the joint A6 and a moment f6R about the axis, as shown in FIG. 2, are calculated.

$$f 6 Z = f \cdot s \qquad ( 1 )$$

$$f 6 R = ( r \times f + M ) \cdot s \qquad ( 2 )$$

where f and M are a force vector and a moment vector of the force Fs detected by the sensor S, respectively, s is a unit vector in the direction of the sixth axis J6, and r is a position vector from the sixth axis J6 to the point of action of the external force input to the tool 7.

Furthermore, by calculating expressions (3) and (4) below, for example, a force f6Y in the axial direction of an arbitrary axis orthogonal to the axis J6 of the joint A6 shown in FIG. 2 and a moment f6Q about the axis are calculated.

$$f 6 Y = \vert s \times ( f \times s ) \vert \qquad ( 3 )$$

$$f 6 Q = \vert s \times ( ( r \times f + M ) \times s ) \vert \qquad ( 4 )$$

Furthermore, the calculation unit 23 performs the same calculation to calculate the forces and the moments in four directions, acting on each of the joints A1 to A5 due to the external force F.

The calculation unit 23 adds the load caused by the weight of the robot 10 or gravity and the inertial force acting on the tool 7 to the calculated forces and moments in the four directions acting on each of the joints A1 to A6. In this way, the calculation unit 23 can calculate the components in the four directions of the total loads f1 to f6 acting on the joints A1 to A6, and the calculated components in the four directions of the total loads f1 to f6 are sent to the determination unit 24.

The load caused by the weight of the robot 10 or gravity acting on the tool 7 is stored in the storage unit 21 in advance. The load caused by the inertial force of the tool 7 is calculated by the calculation unit 23 from the rotation angle information of the motors M1 to M6 fed back to the control unit 22.

Next, the determination unit 24 reads, from the storage unit 21, the allowable values corresponding to the components in the four directions of the loads f1 to f6 acting on the joints A1 to A6. Then, the determination unit 24 calculates the ratios of the components in the four directions of the loads f1 to f6 to be applied to the joints A1 to A6 to the respective allowable values (step S13).

The determination unit 24 transmits the largest ratios among the ratios of the components in the four directions of the loads f1 to f6 to the allowable values, calculated for the joints A1 to A6, to the display unit 25 at predetermined sampling intervals.

The display unit 25 displays the ratios for the joints A1 to A6 transmitted from the determination unit 24 in percentages (step S14). Specifically, the display unit 25 displays, in real time, the ratio of one direction component having the smallest margin with respect to the allowable value in each of the loads f1 to f6 acting on the joints A1 to A6 of the robot 10 to the allowable value.

The determination unit 24 determines whether or not there is at least one joint in which the ratio to be transmitted to the display unit 25 exceeds 100% among the joints A1 to A6 (step S15). As a result of determination, if there is one or more joints in which a ratio higher than 100% is calculated, a predetermined signal is transmitted to the notification unit 26. Then, the notification unit 26 activates an alarm, a warning lamp, or the like on the basis of the signal from the determination unit 24 to prompt the operator to check the display unit 25 (step S16).

As described above, with the robot system 100, the diagnostic device 30, the diagnostic method, and the diagnostic program according to this embodiment, it is possible to also evaluate the loads acting in directions other than the directions about the axes J1 to J6 of the joints A1 to A6.

Thus, for example, even if an excessive load acts on any of the joints A1 to A6 in a direction different from the driving direction of that joint, the operator can easily grasp the situation by checking the display unit 25. Then, the operator can take a measure, such as stopping the operation of the robot 10, to prevent an excessive load from being continuously applied to the robot 10.

In this embodiment, the sensor S is attached between the third wrist component 6c and the tool 7 but, it is not limited to this. For example, it may be disposed between the floor B on which the robot 10 is installed and the base 2.

In that case, the sensor S disposed between the floor B and the base 2 detects a force acting on the base 2, and the loads f1 to f6 acting on the joints A1 to A6 can be calculated by using the detected force in the same manner as described above. Thus, it is possible to prevent an excessive load from acting in directions about the drive shafts of the joints A1 to A6 and in directions other than the directions about the drive shafts.

In this embodiment, the joints A1 to A6 of the robot 10 are rotary joints that rotate about the axes J1 to J6. Instead of this, at least one of the joints A1 to A6 may be a linear motion joint that is driven along a predetermined axis.

In this embodiment, the robot 10 includes the six joints A1 to A6, but it is not limited to this. The same effects as those described above can be obtained as long as the robot 10 has two or more joints.

In this embodiment, the diagnostic device 30 evaluates the loads f1 to f6 acting on the joints A1 to A6, respectively, by using the allowable values set in advance for the joints A1 to A6. Instead of this, the diagnostic device 30 may use thresholds calculated on the basis of the allowable values. For example, the thresholds may be values obtained by multiplying the allowable values by a safety factor larger than 0 and smaller than or equal to 1.

This makes it possible to evaluate the loads acting on the joints A1 to A6 while providing margins with respect to the allowable values. Hence, it is possible to more reliably prevent loads higher than or equal to the allowable values from being applied to the joints A1 to A6.

In this embodiment, the calculation unit 23 constantly calculates the forces and the moments in multiple directions acting on the joints A1 to A6 at predetermined sampling intervals during the operation of the robot 10. Instead of this, the calculation unit 23 may calculate the forces and the moments in multiple directions acting on the joints A1 to A6 only in a predetermined section t of the operation program. In that case, for example, commands for starting diagnosis and ending diagnosis are arranged at the start point and the end point of the predetermined section t of the operation program.

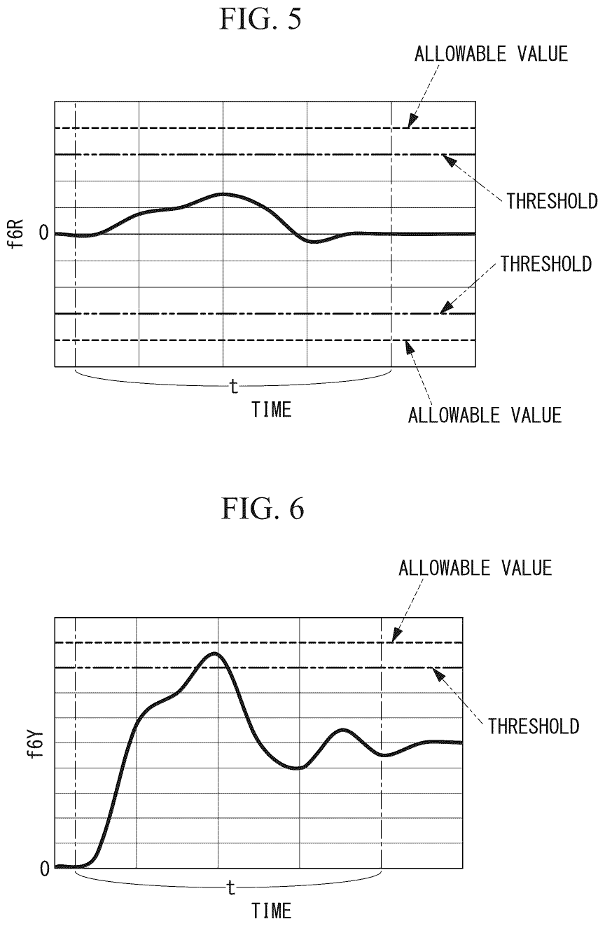

By doing so, the calculation unit 23 calculates the loads f1 to f6 acting on the joints A1 to A6 only during a period from when the diagnosis start command is executed to when the diagnosis end command is executed in the operation program. Then, the forces and the moments in multiple directions for each joint calculated by the calculation unit 23 in the predetermined section t can be stored as waveforms, as shown in FIGS. 5 and 6, in the storage unit (recording unit) 21.

For example, FIG. 5 shows a temporal change of a moment f6R (see FIG. 2) acting about the axis J6 of the joint A6, and FIG. 6 shows a temporal change of the force f6Y (see FIG. 2) acting in an arbitrary axial direction orthogonal to the axis J6.

In this case, the determination unit 24 compares the maximum values in the waveforms of the moment f6R and the force f6Y in the predetermined section t with their corresponding allowable values.

Alternatively, the determination unit 24 may average, for example, the waveforms of the moment f6R and the force f6Y for multiple times recorded in the storage unit 21 and multiply the averaged maximum value by a predetermined coefficient, for example, 1.1 or the like, to set thresholds. Then, it may be determined whether or not the moments f6R and the forces f6Y calculated next time and thereafter exceed the set thresholds.

In this way, in the case where a force or a moment in any direction acting on any joint exceeds a threshold in a repeatedly performed task, it is possible to confirm that a temporal change of a mechanism unit of the robot 10 has occurred. The coefficient to be multiplied for setting the threshold may be arbitrarily set by the operator.

The operator can arbitrarily edit the timing of starting diagnosis and ending diagnosis. That is, the operator may arbitrarily adjust the positions in the operation program where the diagnosis start and diagnosis end commands are inserted.

For example, when the operation program is created as a list of icons indicating various commands, the operation program can be easily edited by inserting a diagnosis start icon and a diagnosis end icon between arbitrary icons.

The icons may include additional information. For example, when the robot 10 is caused to perform a screw fastening task with the tool 7, signal information, such as fastening start/completion, OK/NOT OK, and a fastening program number may be associated with the icons so that the signal information can be input to and output from the tool 7. Alternatively, the icons may be used to select an axis of the tool coordinate system of a tool 7 to be used, or may be used to set the magnitude of force when the tool 7 is driven.

Next, a robot system 200, a diagnostic device 230, a diagnostic method, and a diagnostic program according to a second embodiment of the present disclosure will be described below with reference to the drawings.

In the following description, the same components as those of the robot system 100 and the diagnostic device 30 described above will be denoted by the same reference numerals, and the description thereof will be omitted.

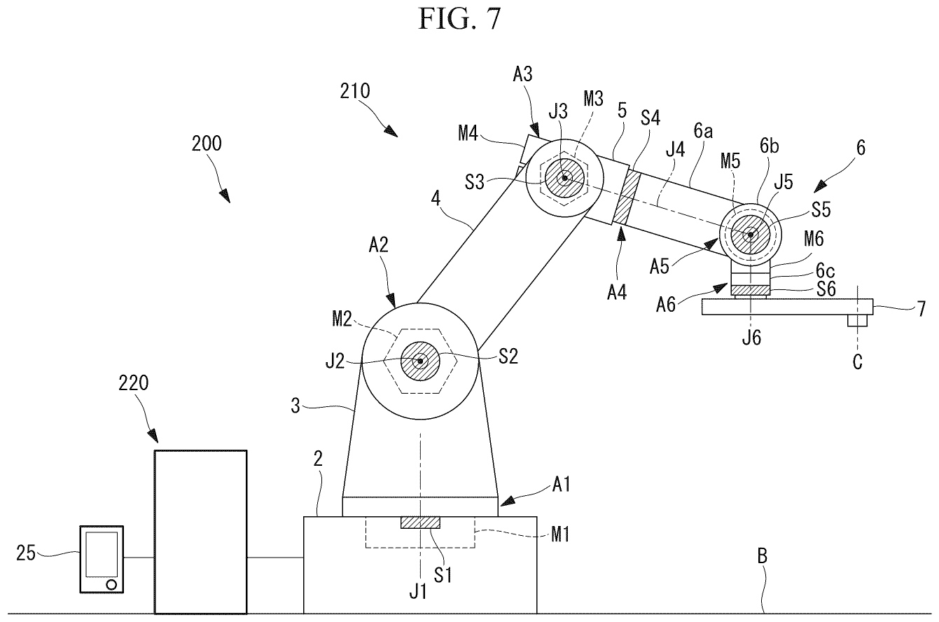

As shown in FIG. 7, a robot 210 of the robot system 200 according to this embodiment includes torque sensors S1 to S6 respectively attached to the joints A1 to A6, instead of the force sensor S attached to the wrist unit 6.

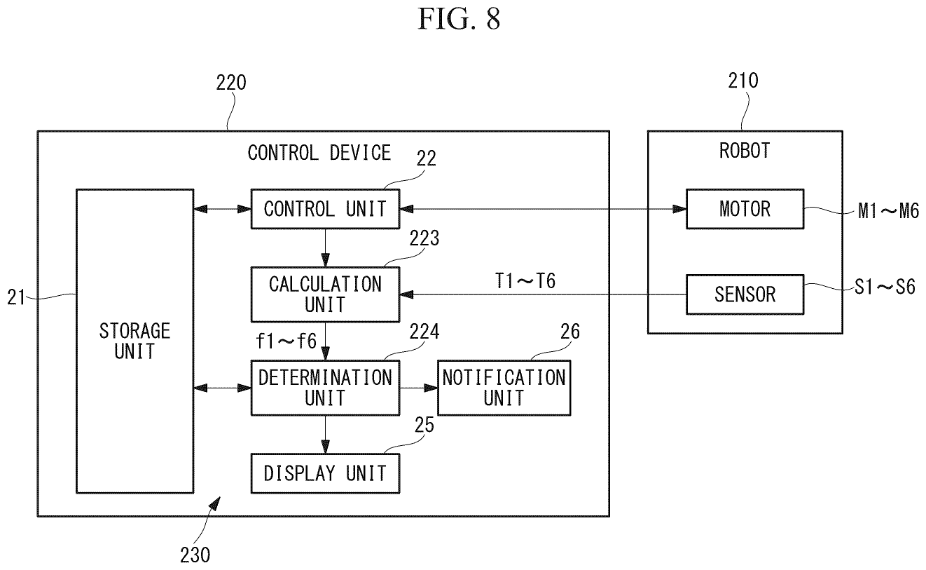

As shown in FIG. 8, a control device 220 includes a diagnostic device 230. The diagnostic device 230 includes a calculation unit 223 and a determination unit 224.

The torque sensors S1 to S6 detect torques T1 to T6 about the axes J1 to J6 acting on the joints A1 to A6, and transmit the detected torques T1 to T6 to the control device 220.

The calculation unit 223 calculates a Jacobian matrix on the basis of the posture information of the robot 210 transmitted from the control unit 22. Then, the calculation unit 223 estimates a force Fs acting on the tip of the robot 210 on the basis of the Jacobian matrix and the torques T1 to T6 applied to the joints A1 to A6 detected by the torque sensors S1 to S6.

A robot diagnostic method using the thus-configured robot system 200 and diagnostic device 230 according to this embodiment will be described below.

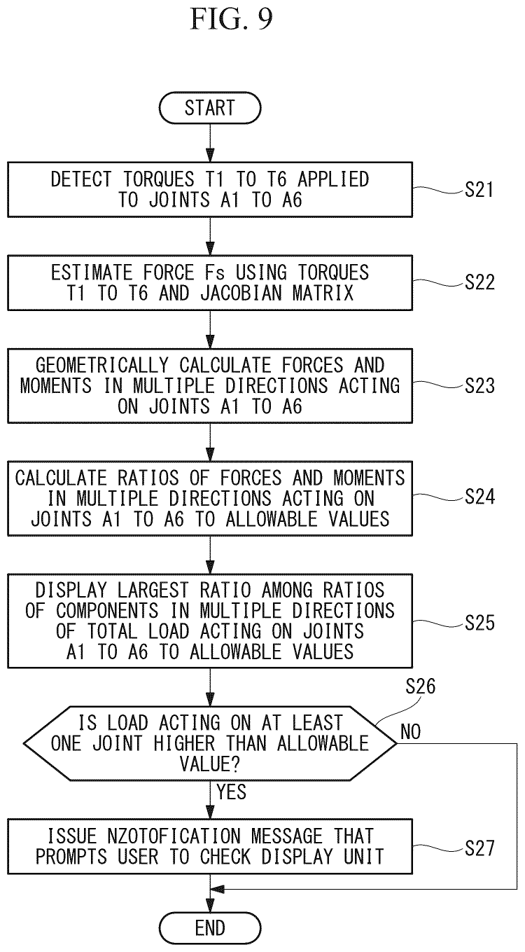

A case where a screw fastening task is performed on a workpiece with a nut runner (tool) 7 attached to the robot 210, similarly to the case described above, will be described below with reference to the flowchart shown in FIG. 9.

First, when an external force F is input to the tool 7 and the diagnostic program is executed, the torques T1 to T6 about the axes J1 to J6 acting on the motors M1 to M6 of the joints A1 to A6 are detected by the torque sensors S1 to S6 (step S21).

Next, the calculation unit 223 calculates a Jacobian matrix to estimate six direction components of the force Fs acting on the third wrist component 6c on the basis of the calculated Jacobian matrix and the torques T1 to T6 transmitted from the torque sensors S1 to S6 (step S22).

Specifically, first, a Jacobian matrix J is defined as shown in the expression below.

$$J = [ \begin{matrix}{s}_{1} & … & {s}_{6} \\ {s}_{1} \times {r}_{1} & … & {s}_{6} \times {r}_{6}\end{matrix} ] \qquad Expression 1$$

where s₁ to s₆ are direction vectors along the axes J1 to J6 of the joints A1 to A6, respectively, and r₁ to r₆ are position vectors directed from the joints A1 to A6 toward the point of action of the force Fs acting on the distal end of the third wrist component 6c, respectively.

A vector V obtained by combining the angular speed ω and the translational speed v of the distal end of the third wrist component 6c of the robot 10 can be expressed by the expression below.

$$V = J {θ}^{′} \qquad Expression 2$$

where θ′ is a vector obtained by collecting all angular speeds of the joints A1 to A6.

Then, by using the relationship shown in the expression above, the vector Fs obtained by combining the forces and the moments acting on the third wrist component 6c of the robot 10 is calculated by the expression below.

$$Fs = - [ \begin{matrix}O & I \\ I & O\end{matrix} ] {J}^{- T} τ = - {[ \begin{matrix}O & I \\ I & O\end{matrix} ] [ \begin{matrix}{s}_{1} & … & {s}_{6} \\ {s}_{1} \times {r}_{1} & … & {s}_{6} \times {r}_{6}\end{matrix} ]}^{- T} τ \qquad Expression 3$$

where t is a vector obtained by collecting the torques acting on all the joints A1 to A6.

In the subsequent steps, the same processing as that in the first embodiment is executed (steps S23 to S27).

As described above, according to this embodiment, the force Fs acting on the third wrist component 6c can be estimated using the torque sensors S1 to S6 provided in the joints A1 to A6 of the robot 210. Then, by calculating the forces and the moments in multiple directions acting on the joints A1 to A6 on the basis of the estimated force Fs, and adding thereto the loads due to the gravity and the inertial force, the total loads f1 to f6 can be calculated.

In this way, it is possible to evaluate the loads in multiple directions acting on the joints A1 to A6, without directly detecting the reaction force F acting on the tool 7 using the six-axis force sensor S.

Thus, for example, even when it is necessary to design a small wrist unit 6 in which a space for attaching the six-axis force sensor S cannot be secured, the same effect as described above can be obtained.

In this embodiment, the force Fs acting on the distal end of the robot 10 is estimated on the basis of the torques T1 to T6 acting on the joints A1 to A6 detected by the torque sensors S1 to S6. Instead of this, the force Fs may be estimated on the basis of the displacements of the joints A1 to A6 detected by secondary encoders provided in the joints A1 to A6. The secondary encoders are detectors that directly detect the displacements of the joints A1 to A6, separately from the encoders provided in the motors M1 to M6. Alternatively, the force Fs may be estimated by using, for example, the current values of the motors M1 to M6 provided in the joints A1 to A6.

The estimation of the force Fs based on the displacements of the joints A1 to A6 or the current values of the motors M1 to M6 may be performed using the Jacobian matrix, as in the case where the force Fs is calculated on the basis of the torques T1 to T6.

In this embodiment, the notification unit 26 has a function of notifying the operator of the presence of a joint on which a load exceeding the allowable value acts when the determination unit 224 has determined that such a joint is present. In addition, the notification unit 26 may function as a singular-point notification unit that notifies the operator of the fact that the posture of the robot 210 approaches a singular point when the posture approaches a singular point.

In that case, for example, the determination unit 224 can determine whether or not the posture of the robot 210 is approaching a singular point by detecting a case in which the determinant of the transpose matrix of the Jacobian matrix calculated by the calculation unit 223 is 0. Then, a predetermined signal based on the determination result is sent from the determination unit 224 to the notification unit 26, and the notification unit 26 sets off an alarm, a warning light, or the like.

In this way, the operator can easily recognize that the robot 210 in operation is approaching a singular point, and can prevent the robot 210 from taking a singular posture.

In the embodiments described above, when the determination unit 24, 224 determines that an excessive load is applied to any of the joints A1 to A6, the control device 20, 220 may automatically change the posture of the robot 10, 210.

In that case, a posture search program for changing the posture of the robot 210 may be stored in the storage unit 21.

Then, when the determination unit 24, 224 determines that a load exceeding the allowable value is applied to the specific joint, a signal is transmitted from the determination unit 24, 224 to the control unit 22. Then, the control unit 22 interrupts the operation program being executed, and reads out a posture search program from the storage unit 21 and executes the posture search program.

As a result, in the robot 10, 210, for example, the joints A1 to A6 are minutely moved within the movable ranges in the posture and the operation situation at that time. Then, each time each joint is minutely moved, the determination unit 24, 224 executes a diagnostic program to diagnose the magnitude of the load acting on a specific joint. In this way, the determination unit 24, 224 can search for a posture of the robot 10, 210 in which the load acting on the specific joint is reduced, and change the posture of the robot 10, 210 to that posture.

The control device 20 that controls the robot 10 may simulate a minute movement of each joint to search for a posture of the robot 10, 210 in which the load acting on the specific joint is reduced.

Although the embodiments of the present disclosure have been described in detail above, the present disclosure is not limited to the above-described embodiments. Various additions, substitutions, changes, partial deletions, and the like can be made to these embodiments without departing from the spirit of the invention, or without departing from the spirit and scope of the invention derived from the contents described in the claims and equivalents thereof. For example, in the above-described embodiments, the order of operations and the order of processes are shown as examples and are not exhaustive.

1. A robot system comprising:
a robot having two or more joints;
a sensor capable of detecting a physical quantity for measuring or estimating an external force acting on the robot; and
a diagnostic device that diagnoses the robot,
wherein the diagnostic device calculates a force acting on each joint in at least one direction other than an operation direction of that joint on a basis of the external force measured or estimated from the physical quantity detected by the sensor.

2. The robot system according to claim 1, wherein the diagnostic device determines whether or not either of calculated values including the calculated force and a value obtained based on the force is within a range of a corresponding allowable value.

3. The robot system according to claim 1, wherein the sensor is disposed between an installation surface of the robot and a point of action of the external force.

4. The robot system according to claim 2, wherein
the robot comprises six joints, and
the sensor is provided in each of the joints.

5. The robot system according to claim 4, wherein
each of the joints is a rotary joint, and
the physical quantity is a physical quantity from which a moment about a rotation axis of each of the joints can be measured or estimated.

6. The robot system according to claim 4, wherein the diagnostic device estimates the external force using the physical quantity detected by the sensor and a Jacobian matrix determined by a posture of the robot.

7. The robot system according to claim 4, wherein the diagnostic device comprises a singular-point notification unit that notifies that the posture of the robot is a singular posture when the external force cannot be estimated.

8. The robot system according to claim 2, wherein
the diagnostic device is provided in a control device that controls the robot, and
a start point and an end point of the measurement or estimation of the external force can be set in an operation program executed by the control device.

9. The robot system according to claim 8, wherein the diagnostic device comprises a recording unit that records a maximum value of the calculated values calculated between the start point and the end point.

10. The robot system according to claim 2, wherein the diagnostic device comprises a display unit that displays a ratio of the calculated value to the allowable value.

11. The robot system according to claim 2, wherein the diagnostic device comprises a notification unit that sets a predetermined threshold based on the calculated value and notifies that the calculated value exceeds the threshold when the calculated value exceeds the threshold.

12. The robot system according to claim 2, further comprising a control device, wherein, when the calculated value exceeds the allowable value, the control device causes the robot to perform a minute movement to search for a posture of the robot in which the force decreases.

13. The robot system according to claim 2, further comprising a control device, wherein, when the calculated value exceeds the allowable value, the control device simulates a minute movement of the robot to search for a posture of the robot in which the force decreases.

14. A robot diagnostic device that calculates a force acting on each joint of a robot in at least one direction other than an operation direction of that joint on a basis of a physical quantity for measuring or estimating an external force acting on the robot detected by a sensor.

15. The robot diagnostic device according to claim 14, wherein it is determined whether or not either of calculated values including the calculated force and a value obtained based on the force is within a range of a corresponding allowable value.

16. A robot diagnostic method comprising:
measuring or estimating an external force acting on a robot having two or more joints on a basis of a physical quantity acting on the robot, detected by a sensor; and
calculating a force acting on each of the joints in at least one direction other than an operation direction of that joint on a basis of the measured or estimated external force.

17. The robot diagnostic method according to claim 16, further comprising determining whether or not either of calculated values including the calculated force and a value obtained based on the force is within a range of a corresponding allowable value.

18. A non-transitory computer readable medium storing a robot diagnostic program that causes a computer to execute:
measuring or estimating an external force acting on a robot having two or more joints on a basis of a physical quantity acting on the robot detected by a sensor; and
calculating a force acting on each of the joints in at least one direction other than a driving direction of that joint on a basis of the measured or estimated external force.

19. The non-transitory computer readable medium according to claim 18, wherein the diagnostic program causes the computer to execute determining whether or not either of calculated values including the calculated force and a value obtained based on the force is within a range of a corresponding allowable value.
